(19) United States
(12) Patent Application Publication
(10) Pub. No.: US 2006/0229399 A1
(43) Pub. Date: Oct. 12, 2006

(54) Process for making a thermoplastic vulcanizate composition

(75) Inventors: Louis M. Panzer, Rigdefield, CT (US); Philbert E. Ramdatt, New York, NY (US)

Correspondence Address: GE ADVANCED MATERIALS - SILICONES, 771 OLD SAW MILL RIVER ROAD, TARRYTOWN, NY, 10591-6701, US

(73) Assignee: General Electric Company

(21) Appl. No.: 11/104,104

(22) Filed: Apr. 12, 2005

(51) Int. Cl. C08K 3/26

(52) U.S. Cl. 524/425; 524/502; 525/192; 524/493; 524/431; 524/448; 524/445; 524/437; 524/439

(57) ABSTRACT

A process for making a thermoplastic vulcanizate includes blending a thermoplastic first polymer, an elastomeric second polymer, a carboxylic anhydride, a free radical generator, and a particulate reinforcing material to provide a first blend containing the thermoplastic first polymer and grafted elastomeric second polymer with the particulate reinforcing material dispersed therein, the particulate reinforcing material having sufficient surface moisture to permit coupling to the thermoplastic first polymer and the elastomeric second polymer upon reaction with a coupling agent; then, combining a coupling agent with the first blend for coupling the thermoplastic first polymer and/or grafted elastomeric second polymer with the particulate reinforcing material and/or crosslinking the grafted elastomeric second polymer.

### BACKGROUND OF THE INVENTION

Thermoplastic elastomers (TPEs) exhibit the functional properties of conventional thermoset rubbers, yet they can be melted repeatedly and are therefore suitable for processing in conventional thermoplastic fabrication equipment. The majority of TPEs consist of two phases, one consisting of a rubber material (elastomer) that is insoluble in the other, and a flowable thermoplastic material. The rubber material is present as a dispersed phase and the thermoplastic is the continuous phase.

Although it is in principle not necessary to crosslink the rubber in a TPE, it has proven efficient using crosslinking techniques to obtain better chemical resistance, mechanical properties and a better control of phase separation. Such TPE compositions where a crosslinking reaction and process is used to achieve phase separation into divided domains are called thermoplastic vulcanizates (TPVs). To keep their thermoplastic character, it is essential that only the rubber phase be crosslinked. For an extensive and detailed description and review of TPV technology, see for instance S. Abdou-Sabet, R. C. Puydak and C. P. Rader in Rubber Chemistry and Technology, vol. 69, pp 476-493, 1996.

Furthermore, it has been demonstrated that the mechanical performance of TPVs improves with the degree of crosslinking of the rubbery phase and with the inverse of the particle size of rubbery domains. Dynamic crosslinking (which consists of intimately mixing a blend of compatible polymers, then introducing a crosslinking system in the mixture while the mixing process is continued) is used to generate the finely dispersed, highly crosslinked rubbery phase from a homogeneous blend of polymers.

For thermodynamic and hydrodynamic reasons it is preferred that the polymer viscosity be increased while crosslinking is taking place because the particles tend to agglomerate while the phases are separating. Moreover, if a phase-inversion process can take place while crosslinking, this is favorable to the formation of fibrous rubber domains which may provide specific mechanical properties. However, it has been found preferable to select a crosslinking mechanism that can involve, in part, the thermoplastic phase, not to the point where the thermoplastic character of the TPV is removed, but only to achieve better adhesion and compatibility of the polymers.

The selection of a crosslinking process and chemicals is governed by processing requirements, e.g., reaction rate at the processing temperature, compatibility with the elastomer, side reactions with the thermoplastic, efficiency (number of crosslinks generated by each molecule of crosslinker), absence of undesired reactions, toxicity and hazards, color, and odor.

One example of such TPVs is EPDM/PP described in U.S. Pat. No. 3,130,535. Ethylene-propylene-diene monomer (EPDM) and polypropylene (PP) are mixed intimately in an internal mixer, and a peroxide is added to crosslink the EPDM. Excess peroxide and/or excessively high processing temperature and/or excessively reactive polymers will cause degradation of the PP phase and/or scorch. In contrast, insufficient amount of peroxide and/or too low processing temperature and/or a poorly reactive EPDM will cause insufficient crosslinking.

It was disclosed in EP 0,324,434 to use silane-grafted polymers in the thermoplastic phase. After mixing, the material is shaped and left to react with atmospheric moisture. Thus it was possible to obtain a more elastomeric material after water cure. However the obtained water-cured item no longer contains a thermoplastic elastomer and cannot be recycled. To overcome this limitation, EP 0,409,542 disclosed mixing an EPR (ethylene-propylene rubber) or EPDM with a crystalline ethylene-propylene thermoplastic, an organofunctional silane and a free radical generator. The silane is grafted to the resin by the free radical generator and crosslinking takes place through reaction of the silane with water.

A refinement of the above processes is disclosed in EP 0,510,559 where the EPR or EPDM first is grafted, then mixed to the thermoplastic PP and to a crosslinking additive comprising water. The same process is disclosed using very low or ultra low density polyethylene (VLDPE or ULDPE) to reduce raw materials costs and lower mixing temperatures. See DE 44 02 943. It is also suggested to add simultaneously the PP component and the PE component together with silane and radical generator as a dry compound, the addition of water and condensation catalyst being made in a subsequent stage. However, the addition of water into an extruder at temperatures well above its boiling point is a difficult process. Moreover, the amount of water needed is so low that its metering requires sophisticated instrumentation in contradiction with the aim of the patent.

U.S. Pat. No. 4,146,529 to Yamamoto et al. discloses reacting an acid modified polypropylene with an amino or epoxy silane, but the purpose of such reaction is to use the alkoxy groups to bind to fillers and to react the non-grafted carboxylic anhydride to form low odour, non-volatile products, not to crosslink the alkoxy functionalities amongst themselves. The intent of these compositions is to couple mineral fillers and not to form thermoplastic vulcanizates; or, in the absence of filler, to favor reaction of the amino or epoxy of the silane with free, volatile, non-grafted acid or anhydride.

German Patent DE 196 29 429 teaches (amongst other issues) the use of pre-blends of vinyl silanes, amino silane and unsaturated carboxylic anhydrides which are used for crosslinking of polyolefins respectively.

U.S. Pat. No. 6,448,343 to Schombourg et. al., which is incorporated by reference herein, discloses silane vulcanized thermoplastic elastomers with a gel content of 10% to 50 wt % and elongation of 400%. Compositions claimed consist of a dispersed phase reaction product of a polymer or copolymer, carboxylic acid anhydride, a free radical generator (e.g., a peroxide), and an aminosilane, and a continuous phase of a second polymer. The process describer by Schombourg et al. is a multi-step batch process.

There is yet a need for an improved process for producing TPV.

### BRIEF DESCRIPTION OF THE INVENTION

A process for making a thermoplastic vulcanizate is provided herein. The process comprises (a) blending a thermoplastic first polymer, an elastomeric second polymer, a carboxylic anhydride, a free radical generator, and a particulate reinforcing material to provide a first blend containing the thermoplastic first polymer and grafted elastomeric second polymer with the particulate reinforcing material dispersed therein, said particulate reinforcing material having sufficient surface moisture to permit coupling to both the thermoplastic first polymer and the elastomeric second polymer upon reaction with a coupling agent and/or crosslinking agent; then, (b) combining the coupling agent and/or crosslinking agent with the first blend for coupling the thermoplastic first polymer and/or grafted elastomeric second polymer with the particulate reinforcing material and/or crosslinking the grafted elastomeric second polymer.

The process advantageously provides a thermoplastic vulcanizate product with superior mechanical properties and which uses a less expensive particulate reinforcing material which is better dispersed throughout the blend than pre-treated reinforcing agent. The process can advantageously be performed on a continuous basis or as a batch process. Moreover, the selection of polymers and elastomers is very flexible, allowing for the use of the same material by the mode of addition of the coupling and/or crosslinking agent.

### DETAILED DESCRIPTION OF THE INVENTION

The present invention is directed to silylated thermoplastic vulcanizate (TPV) compositions based upon a dispersed phase of carboxylic acid anhydride modified or peroxide grafted elastomer, reacted with silanes, preferably aminosilanes, a continuous phase thermoplastic, and a particulate reinforcing material such as untreated clay. These compositions exhibit an extended range of mechanical properties over the prior art as described below. The clay can be included in the structure of the TPV composite in several locations: for example, dispersed in the elastomer, dispersed in the thermoplastic phase, partially dispersed in both thermoplastic and elastomer and/or at the interface between the two polymer phases.

More particularly, in one embodiment the TPV compositions are a blend of: (a) a crystalline or partly crystalline thermoplastic first polymer; (b) an elastomeric second polymer (rubber phase); (c) a carboxylic acid anhydride, incorporated as a comonomer in elastomeric component (b) or grafted with a free radical generator such as peroxide or other suitable means onto elastomeric component (b); (d) a silane, preferably an aminosilane, as a crosslinking agent and coupling agent; and (e) an untreated particulate reinforcing material. Alternatively, in another embodiment, the coupling and/or crosslinking agent can be an organic diamine such as, for example, hexamethylene diamine.

In accordance with one embodiment of the invention, based upon total composition weight, the composition includes from about 5 wt % to about 40 wt % of the thermoplastic first polymer, from about 60 wt % to about 95 wt % of the elastomeric second polymer, from about 0.01 wt % to about 1.0 wt % of the carboxylic anhydride, from about 0.005 wt % to about 0.5 wt % of a peroxide; from about 0.25 wt % to about 2.5 wt % of the silane, and from about 1 wt % to about 60 wt % of the untreated particulate reinforcing material.

In accordance with another embodiment of the invention, based upon total composition weight, the composition includes from about 10 wt % to about 30 wt % of the thermoplastic first polymer, from about 70 wt % to about 90 wt % of the elastomeric second polymer, from about 0.05 wt % to about 0.5 wt % of the carboxylic anhydride, from about 0.025 wt % to about 0.25 wt % of peroxide, from about 0.5 wt % to about 2.0 wt % of the silane, and from about 10 wt % to about 50 wt % of the untreated particulate reinforcing material.

In accordance with yet another embodiment of the invention, based upon total composition weight, the composition includes from about 15 wt % to about 25 wt % of the thermoplastic first polymer, from about 75 wt % to about 85 wt % of the elastomeric second polymer, from about 0.1 wt % to about 0.4 wt % of the carboxylic anhydride, from about 0.05 wt % to about 0.2 wt % of peroxide; from about 1.0 wt % to about 2.0 wt % of the silane, and from about 15 wt % to about 40 wt % of the untreated particulate reinforcing material.

In accordance with a preferred embodiment the process of the present invention, in contrast to prior methods of making TPV, is performed in a single operation. Grafting, crosslinking and coupling are performed continuously in the compounding apparatus. However, the process is also suitable for use in a batch compounding system, such as a Banbury or Krupp mixer, if desired.

Use of untreated or partially treated particulate material is an important feature of the invention. By using, for example, a barrel type mixer-extruder (e.g., single screw, twin screw, co-rotating, counter-rotating, intermeshing, non-intermeshing, cylindrical or conical) with single or multiple feed ports, the elastomer, thermoplastic, carboxylic anhydride and untreated particulates can be fed into the mixer at a first entry position or proportionately into several feed ports. After these components have progressed through the unit and have been sufficiently mixed, the silane (or other type coupling or crosslinking agent) is added downstream and then blended into the composition. Thus, the untreated particulates are already dispersed throughout the thermoplastic matrix polymer and the elastomer when the coupling reaction between the particulates and the silane is initiated. This achieves superior mechanical properties because the individual particles are bonded both to the thermoplastic matrix polymer and the elastomer, thereby serving as a link between the two. In another embodiment the invention includes coupling of the particulate material into either, or both of, the first and second polymers. The silane effects curing of the grafted resin and improves the mechanical properties and chemical resistance of the resulting product.

For the matrix polymer, suitable thermoplastic polymers (a) include polypropylene (PP), polyethylene (PE), especially high density polyethylene (HDPE), polystyrene (PS), acrylonitrile butadiene styrene (ABS), styrene acrylonitrile (SAN), polymethylmethacrylate (PMMA), thermoplastic polyesters (PET, PBT), polycarbonate (PC), polyamide (PA), polyphenylene ether (PPE) or polyphenylene oxide (PPO).

Such polymers may be made by any process known in the art, including, but not limited to, by bulk phase, slurry phase, gas phase, solvent phase, interfacial, polymerization (radical, ionic, metal initiated (e.g., metallocene, Ziegler-Natta)), polycondensation, polyaddition or combinations of these methodologies.

It is possible to have the polymers for the two phases be the same wherein the acid anhydride is pre-added along with peroxide or other method of grafting, to one part of the polymer, which pre-reacted polymer will act as the rubber phase within the TPV. The rubbery phase is generally the dispersed phase of the TPV or can be co-continuous, depending on the selection of resins and processing conditions. Such pre-addition includes the possibilities of having the acid anhydride present as a comonomer in the polymer or pre-reacting the acid anhydride with the polymer. In either of these two cases, the addition of the separate acid anhydride would not be necessary since it is present in the polymer. This process can be accomplished in a single continuous mixer, several mixers in tandem, a batch mixer or any other suitable mixer typically used for the processing of elastomers and thermoplastic polymers.

For the rubber phase, or dispersed or co-continuous phase, suitable polyolefin rubber phase components (b) include any polymer which can be reacted (by peroxide grafting or other suitable means) such as to yield an carboxylic anhydride containing polymer like, e.g., ethylene propylene copolymer (EPR); ethylene propylene diene terpolymer (EPDM), butyl rubber (BR); natural rubber (NR); chlorinated polyethylene (CPE); silicone rubber; isoprene rubber (IR); butadiene rubber (BR); styrene-butadiene rubber (SBR); styrene-ethylene butylene-styrene block copolymer (SEBS); ethylene-vinyl acetate (EVA); ethylene butylacrylate (EBA), ethylene methacrylate (EMA), ethylene ethylacrylate (EEA), ethylene-alpha-olefin copolymers (e.g., EXACT and ENGAGE, LLDPE (linear low density polyethylene)), high density polyethylene (HDPE), nitrile rubber (NBR) and styrene block copolymers (e.g., polystyrene end blocks with polydiene midblocks, typically either polybutadiene or polyisoprene midblocks) and grafted, reacted or functionalized variants thereof. Polypropylene is not suitable as this phase since it has a tendency to degrade during crosslinking. However, if the polypropylene is a copolymer or graftomer of polypropylene with an acid anhydride, then it may be used. Preferably, the polymer is an ethylene polymer or copolymer with at least 50% ethylene content (by monomer), more preferably at least 70% of the monomers are ethylene.

A third alternative is that the polymer of the rubber phase and the thermoplastic phase can be the same polymer, but the acid anhydride is added to the polymer as a whole. In such a case when the silane is added part of the polymer would form the rubber phase, while another part would not react (given the relatively small amount of anhydride and silane present). It is important that a proper degree of phase separation between the rubber and thermoplastic phases is created during the process. This process can be accomplished in a single continuous mixer, several mixers in tandem, a batch mixer or any other suitable mixer typically used for the processing of elastomers and thermoplastic polymers.

In the case of two different polymers, the polymer that is more reactive with the acid anhydride will be grafted by the acid anhydride and will act as the rubber phase in the TPV. However, if desired, the process is flexible and can be modified by the selective addition of the additives to the process.

The polymer which is to become the rubber phase (or dispersed or co-continuous phase) must be processable and should be capable of grafting with the acid anhydride or be modified by acid anhydride during its manufacture.

The melting point of the thermoplastic phase should be less than the decomposition temperature of the aminosilane, as well as the decomposition temperature of the acid anhydride (unless the acid anhydride is a comonomer in the polymer).

The polymers may have unimodal, bimodal or multimodal molecular weight distributions. The melt flow of the polymers may be any of those known in the art for use in forming thermoplastics and rubbers.

Any carboxylic acid anhydrides which can be grafted or reacted onto or into the polymer to be the rubber phase by any possible mechanism may be used. It is preferable, that there be an unsaturation either in the polymer, or more preferably, in the acid anhydride, to accomplish this grafting. The unsaturation of the carboxylic acid anhydride may be internal or external to a ring structure, if present, so long as it allows for reaction with the polymer. The acid anhydride may include halides. Mixtures of different carboxylic acid anhydrides may be used. Exemplary unsaturated carboxylic acid anhydrides suitable for use in the present invention include, but are not limited to, isobutenylsuccinic, (+/−)-2-octen-1-ylsuccinic, itaconic, 2-dodecen-1-ylsuccinic, cis-1,2,3,6-tetrahydrophthalic, cis-5-norbornene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxylic, 3,4,5,6-tetrahydrophthalic, bromomaleic, and dichloromaleic anhydrides.

These acid anhydrides can be present as a comonomer in the polymer of the rubber phase or can be grafted onto the polymer which will be the rubber phase.

The amount of acid anhydride used can be about 0.01 wt % to about 1.0 wt % based on the total amount of polymer present. The free radical generator (preferably peroxide) is usually present in about half the percentage by weight of the carboxylic acid anhydride, although other percentage amounts can be used where appropriate.

The coupling and/or crosslinking agent can be, for example, a silane or an organic diamine (e.g., hexamethylene diamine). In one embodiment, the silane for use herein is preferably an aminosilane having at least one hydrolyzable group, e.g., alkoxy, acetoxy or halo, preferably alkoxy. In an embodiment, there are at least two such hydrolyzable groups capable of undergoing crosslinking condensation reaction so that the resulting compound is capable of undergoing such crosslinking. A mixture of different aminosilanes may be used. In another embodiment the silane can be a vinyl silane, vinyl aminosilane or mixture thereof.

The amine must have a sufficient rate of reaction with the acid anhydride. Generally, tertiary amines do not react appropriately with the acid anhydride and should be avoided. The amino group may be bridged to the silicon atom by a branched group to reduce yellowing of the resulting composition.

The silane may be represented by the formula YNHBSi(OR)ₐ (X)₃₋ₐ, wherein a=1 to 3, preferably 3, Y is hydrogen, an alkyl, alkenyl, hydroxy alkyl, alkaryl, alkylsilyl, alkylamine, C(═O)OR or C(═O)NR, R is an acyl, alkyl, aryl or alkaryl, X may be R or halo. B is a divalent bridging group, which preferably is alkylene, which may be branched (e.g. neohexylene) or cyclic. B may contain heteroatom bridges, e.g., an ether bond. Preferably B is propylene. Preferably, R is methyl or ethyl. Methoxy containing silanes may ensure a better crosslinking performance than ethoxy groups. Preferably, Y is an amino alkyl, hydrogen, or alkyl. More preferably, Y is hydrogen or a primary amino alkyl (e.g., aminoethyl). Preferably, X is Cl or methyl, more preferably methyl. Exemplary silanes are gamma-amino propyl trimethoxy silane (SILQUEST® A-1110 available from General Electric Company); gamma-amino propyl triethoxy silane (SILQUEST® A-1100); gamma-amino propyl methyl diethoxy silane; 4-amino-3,3-dimethyl butyl triethoxy silane, 4-amino-3,3-dimethyl butyl methyldiethoxysilane, N-beta-(aminoethyl)-gamma-aminopropyltrimethoxysilane (SILQUEST® A-1120), H₂NCH₂CH₂NHCH₂CH₂NH(CH₂)₃Si(OCH₃)₃ (SILQUEST® A-1130) and N-beta-(aminoethyl)-gamma-aminopropylmethyldimethoxysilane (SILQUEST® A-2120). Other suitable amino silanes are as follows: 3-(N-allylamino)propyltrimethoxysilane, 4-aminobutyltriethoxysilane, 4-aminobutyltrimethoxysilane, (aminoethylaminomethyl)-phenethyltrimethoxysilane, aminophenyltrimethoxysilane, 3-(1-aminopropoxy)-3,3,dimethlyl-1-propenyltrimethoxysilane, bis[(3-trimethoxysilyl)-propyl]ethylenediamine, N-methylaminopropyltrimethoxysilane, bis-(gamma-triethoxysilylpropyl)amine (SILQUEST® A-1170), and N-phenyl-gamma-aminopropyltrimethoxysilane (SILQUEST® Y-9669).

If the aminosilane is a latent aminosilane, i.e., a ureidosilane or a carbamatosilane, then the blending temperature must be sufficient so that the respective blocking group comes off from the amine and allows the amine to react with the acid anhydride functionality, about 150 to 230 EC. Examples of such latent aminosilanes are tert-butyl-N-(3-trimethoxysilylpropyl)carbamate, ureidopropyltriethoxysilane, and ureidopropyltrimethoxysilane. Other carbamato silanes which may be used are disclosed in U.S. Pat. No. 5,220,047, which is incorporated herein by reference. Preferably, so as to avoid the additional complexity of deblocking, the aminosilane is not such a latent aminosilane.

The aminosilane should be present at 250 to 25,000 ppm based on weight of both polymers. It should also be present at a molar equivalency ratio to the acid anhydride of about 0.1 to 10, more preferably 0.9 to 1.1, most preferably, about a 1:1 ratio.

The silane can be carried on a porous particulate carrier or a high surface area carrier. The carrier can be, for example, a porous polyolefin or other polymer, silica, titanium dioxide, carbon black or diatomaceous earth so that it is easy to add to the polymer during the mixing process. The silane can also be mixed with a compatible wax to make free flowing pellets or particulates for continuous processes and/or easily added solid materials for batch processes. The silane can also be blended with a compatible processing oil. This is especially useful in formulations that already contain oil and/or will benefit from the use of an oil as a processing aid, plasticizer, lower oil absorption formulation and/or softening agent. Exemplary materials are ACCUREL polyolefin (Akzo Nobel), STAMYPOR polyolefin (DSM) and VALTEC polyolefin (Montell), SPHERILENE polyolefin (Montell), AEROSIL silica (Degussa), MICRO-CEL E (Manville) and ENSACO 350G carbon black (MMM Carbon). White oils, i.e., paraffinic oils, paraffinic waxes, are useful carriers for the silane, but any oil or wax compatible with the silane and the composite formulation can be used.

The reinforcing agent should be untreated, i.e., it should not be treated by any method which substantially eliminates the surface moisture naturally occurring on the particles of the reinforcing agent. Alternatively, a minimally treated reinforcing agent (with a treatment compatible with the purposes described herein) can be used which will benefit from the continuous addition and reaction during the process described herein. Particulates used in prior known processes are usually pre-treated with silane or are calcined or pre-treated in various ways which typically eliminate the surface moisture on such particles. Untreated (or partially treated) particles have sufficient surface moisture to facilitate coupling with the matrix and elastomeric polymers upon reaction with the silane during the blending process. Moreover, use of untreated particulate reinforcing material eliminates the need for an added step and uses less costly material. Particulate material suitable for use in the invention include, but are not limited to, one or more of untreated clays (aluminosilicates), talc, Mg(OH)₂, calcium carbonate, glass, aluminum, copper, ferrous metals and alloys, nickel, zinc, lead, mica, inorganic oxides (e.g., MgO, silica, alumina, titania, zirconia, etc.) and the like.

The composition can include various optional additives. A free radical generator would be required if the carboxylic acid anhydride is being grafted by a free radical mechanism onto the polymer, but it is not required if the acid anhydride is either grafted via another mechanism or being a comonomer of the polymer. Suitable free-radical catalysts may be selected from the group of water soluble or oil soluble peroxides, such as hydrogen peroxide, ammonium persulfate, potassium persulfate, various organic peroxy catalysts, such as dialkyl peroxides, e.g., diisopropyl peroxide, dilauryl peroxide, di-t-butyl peroxide, di(2-t-butylperoxyisopropyl)benzene, 3,3,5-trimethyl 1,1-di(tert-butyl peroxy)cylohexane; 2,5-dimethyl-2,5-di(t-butylperoxy)hexane, 2,5-dimethyl-2,5-di(t-butylperoxy)hexyne-3; dicumyl peroxide, alkyl hydrogen peroxides such as t-butyl hydrogen peroxide, t-amyl hydrogen peroxide, cumyl hydrogen peroxide, diacyl peroxides, for instance acetyl peroxide, lauroyl peroxide, benzoyl peroxide, peroxy ester such as ethyl peroxybenzoate, and the azo compounds such as 2-azobis(isobutyronitrile).

The free radical generator may be present at 1/100 to 1/1 based on the molar quantity of the acid anhydride.

Standard additives such as stabilizers (UV, light or aging), antioxidants, metal deactivators, processing aids, waxes, fillers, and colorants may be added to the TPV. Additionally, blowing agents may be added to the polymers so that when they are extruded the polymer will form a foam. Examples of such blowing agents are volatile hydrocarbons, hydrofluorocarbons, and chlorofluorocarbons. Commonly known foaming agent like azocarbonamide or sodium bicarbonate decompose at elevated temperature to yield gaseous products. These are all chemical foaming processes. Foams can also be produced by injection of liquid or gaseous foaming agent into the polymer melt. Examples are, e.g., butane, CO₂, nitrogen, water, helium, etc. The amount of such a blowing agent should be about 0.1 to about 5.0 weight percent of the polymers.

The process of the invention can advantageously be performed as a continuous process and operated in a single step. Alternatively, the process can be a batch process. Any mixer suitable for the purpose described herein can be used. A preferred mixer is a screw type mixer with at least one feed port located at an upstream position along the barrel of the mixer and an injection port located at a downstream position along the barrel. Mixers with additional feed ports can be used to advantage by introducing ingredients at several points along the barrel to optimize the process. The mixer can be an extruder (single screw, twin screw, etc.), a BUSS KO-KNEADER mixer or a simple internal type mixer. The conditions for mixing depend on the polymers and degree of crosslinking.

The thermoplastic matrix polymer, elastomer, acid anhydride, untreated particulate reinforcing material, and optional other components such as those listed above, are fed into the mixer at the upstream location or can be added as divided portions added in several ports as long as the silane is added later in the process. In a continuous mixer, mixing, coupling and grafting occur in an upstream first portion of the mixer. Silane or other coupling or crosslinking agent is added at the down stream injection port. Coupling between the reinforcing agent particles and both the thermoplastic and elastomer polymers, as well as crosslinking of the elastomer, occurs in a downstream second portion of the mixer between the downstream second feed port and the outlet of the mixer. In some cases the curing continues for some time after the compounded material is processed.

The resulting product is a thermoplastic vulcanizate with excellent mechanical properties because of superior dispersion of the particulate reinforcing material and the matrix-particulate-elastomer coupling.

The following examples illustrate the invention. The comparative examples are provided for comparison purposes only and do not illustrate the invention.

### EXAMPLES

The following materials were used in the examples and comparative examples:

| | |
|---|---|
| Royalene ® 694 | EPDM rubber. A terpolymer of ethylene, propylene, |
| | and non-conjugated diene extended with 75 phr of a |
| | clear, non-staining paraffinic oil. Available from |
| | Uniroyal Chemical. |
| Royalene ® 4697 | EPDM rubber. A terpolymer of ethylene, propylene, |
| | and non-conjugated diene extended with 100 phr of |
| | a white, hydrotreated paraffinic oil. Available |
| | from Uniroyal Chemical. |
| Profax ™ 6523 | General purpose propylene homopolymer. |
| | Available from Basell Service Co. |
| Engelhard ® Clay | A calcined and surface treated aluminosilicate |
| | available under the designation Translink ® from |
| | Engelhard Co. |
| Burgess ® Clay | An untreated aluminosilicate. |
| Naugard ® 10 | Antioxidant for rubber |
| Silcross ® 11 | A blend of Silquest ® A-1100 aminosilane, and |
| | white oil available from General Electric Company. |

A single screw rotating and reciprocating kneader available from BUSS was fitted with two injection ports. All components except the silane were introduced into the mixer through the upstream injection port. The silane was introduced through a downstream injection port. The resulting product was tested for mechanical properties in accordance with standardized test methods. Specific gravity was measured in accordance with ASTM D792; tensile strength and elongation were measured in accordance with ASTM D638; modulus was measured in accordance with ASTM D790. The results are shown in Table 1 below. Examples A, B and C are comparative examples and do not illustrate the invention. Example A employs no reinforcing agent. Examples B and C employ clay. Examples 1, 2 and 3 illustrate the invention.

TABLE 1
Compositions in parts by weight

| | Examples | | | | | |
|---|---|---|---|---|---|---|
| | A | 1 | 2 | 3 | B | C |
| Royalene ® | 78.9 | 62.4 | 62.1 | | 62.4 | |
| 694 Elastomer | | | | | | |
| Royalene ® | | | | 62.4 | | 62.4 |
| 4697 Elastomer | | | | | | |
| Profax 6523 | 19.0 | 19.1 | 18.4 | 19.1 | 19.1 | 19.1 |
| Polypropylene | | | | | | |
| Maleic | 1.0 | 0.9 | 0.9 | 0.9 | 0.9 | 0.9 |
| Anhydride/ | | | | | | |
| peroxide | | | | | | |
| masterbatch | | | | | | |
| Silcross ™ | 1.09 | 0.91 | 1.37 | 0.91 | 0.91 | |
| 11 Silane | | | | | | |
| blend | | | | | | |
| Untreated | | 16.5 | 16.5 | 16.5 | | |
| Clay | | | | | | |
| (Burgess) | | | | | | |
| Treated Clay | | | | | 16.5 | 16.5 |
| (Engelhard) | | | | | | |
| Antioxidant | | 0.19 | 0.19 | 0.19 | 0.19 | 0.19 |
| (Naugard 10) | | | | | | |
| Melt | 410 | 400 | 400 | 408 | 404 | 405 |
| Temperature | | | | | | |
| (° C.) | | | | | | |
| Output | 42 | 42 | 43 | 43 | 44 | 43 |
| (lbs/hr) | | | | | | |
| Physical | | | | | | |
| Properties | | | | | | |
| Specific | 0.92 | 1.0 | 1.09 | 1.01 | 1.0 | 1.0 |
| Gravity | | | | | | |
| Durometer | 72/68 | 82/79 | 82/79 | 85/83 | | |
| Hardness | 77/73 | 86/82 | 85/83 | 85/83 | | |
| Shore A | | | | | | |
| Tensile | 1020 | 1207 | 1141 | 1271 | 1076 | 1089 |
| Strength, | | | | | | |
| psi | | | | | | |
| Elongation, | 351 | 240 | 267 | 315 | 256 | 328 |
| % | | | | | | |
| Modulus at | 291 | 503 | 423 | 403 | | |
| break, psi | | | | | | |
| Tear, ppi | 185 | 208 | 216 | 215 | 211 | 219 |
| Compression | | | | | | |
| set | | | | | | |
| 22 hrs @ | 35 | 36 | 40 | | | |
| 100° C. | | | | | | |
| 22 hrs @ | | | | 41.0 | | |
| 125° C. | | | | | | |

As can be seen from the above results, Examples 1, 2 and 3 of the invention have higher tensile strengths (1207, 1141, and 1271, respectively) than any of the comparative examples A, B or C. The modulus at break and the hardness are higher for Examples 1, 2 and 3 than comparative Example A.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A process for making a thermoplastic vulcanizate comprising:
a) blending a thermoplastic first polymer, an elastomeric second polymer, a carboxylic anhydride, a free radical generator, and a particulate reinforcing material to provide a first blend containing the thermoplastic first polymer and grafted elastomeric second polymer with the particulate reinforcing material dispersed therein, said particulate reinforcing material having sufficient surface moisture to permit coupling to the thermoplastic first polymer and/or the elastomeric second polymer upon reaction with a coupling agent and/or crosslinking agent; then,
b) combining the coupling agent and/or crosslinking agent with the first blend for coupling the thermoplastic first polymer and grafted elastomeric second polymer with the particulate reinforcing material and/or crosslinking the grafted elastomeric second polymer.

2. The process of claim 1 wherein the thermoplastic first polymer comprises one or more polymer selected from the group consisting of homopolymers and copolymers of polypropylene, polyethylene, polystyrene, acrylonitrile butadiene styrene, styrene acrylonitrile, polymethylmethacrylate, thermoplastic polyesters, polycarbonate, polyamide, polyphenylene ether and mixtures thereof.

3. The process of claim 1 wherein the elastomeric second polymer comprises one or more polymers selected from the group consisting of ethylene propylene copolymer, ethylene propylene diene terpolymer, butyl rubber, natural rubber, chlorinated polyethylene, silicone rubber, isoprene rubber, butadiene rubber, styrene-butadiene rubber, ethylene-vinyl acetate, ethylene butylacrylate, ethylene methacrylate, ethylene ethylacrylate, ethylene-alpha-olefin copolymers, high density polyethylene, nitrile rubber, styrene block copolymers and grafted, reacted or functionalized variants thereof.

4. The process of claim 1 wherein the carboxylic anhydride is selected from the group consisting of isobutenylsuccinic, (+/−)-2-octen-1-ylsuccinic, itaconic, 2-dodecen-1-ylsuccinic, cis-1,2,3,6-tetrahydrophthalic, cis-5-norbornene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxylic, 3,4,5,6-tetrahydrophthalic, bromomaleic and dichloromaleic anhydrides.

5. The process of claim 1 wherein the coupling agent is a silane having the formula
YNHBSi(OR)ₐ(X)₃₋ₐ,
wherein a=1 to 3, Y is hydrogen, an alkyl, alkenyl, hydroxy alkyl, alkaryl, alkylsilyl, alkylamine, C(═O)OR or C(═O)NR, R is an acyl, alkyl, aryl or alkaryl, X is R or a halogen wherein R is methyl or ethyl, B is a divalent straight chain, branched chain or cyclic hydrocarbon bridging group, or B may contain heteroatom bridges.

6. The process of claim 5 wherein R is methyl, Y is an amino alkyl, hydrogen, or alkyl, and X is Cl or methyl.

7. The process of claim 1 wherein the coupling agent is a silane selected from the group consisting of gamma-amino propyl trimethoxy silane, gamma-amino propyl triethoxy silane, gamma-amino propyl methyl diethoxy silane, 4-amino-3,3-dimethyl butyl triethoxy silane, 4-amino-3,3-dimethyl butyl methyldiethoxysilane, N-beta-(aminoethyl)-gamma-aminopropyltrimethoxysilane, H₂NCH₂CH₂NHCH₂CH₂NH(CH₂)₃Si(OCH₃)₃, N-beta-(aminoethyl)-gamma-aminopropylmethyldimethoxysilane, 3-(N-allylamino)propyltrimethoxysilane, 4-aminobutyltriethoxysilane, 4-aminobutyltrimethoxysilane, (aminoethylaminomethyl)-phenethyltrimethoxysilane, aminophenyltrimethoxysilane, 3-(1-aminopropoxy)-3,3,dimethlyl-1-propenyltrimethoxysilane, bis[(3-trimethoxysilyl)-propyl]ethylenediamine, N-methylaminopropyltrimethoxysilane, bis-(gamma-triethoxysilylpropyl)amine, N-phenyl-gamma-aminopropyltrimethoxysilane, tert-butyl-N-(3-trimethoxysilylpropyl)carbamate, ureidopropyltriethoxysilane and ureidopropyltrimethoxysilane.

8. The process of claim 1 wherein the silane is carried on a porous particulate carrier or high surface area carrier or is pre-processed with a polymer.

9. The process of claim 8 wherein the porous particulate carrier or high surface area carrier is selected from silica, titanium dioxide, carbon black, diatomaceous earth and polyolefins.

10. The process of claim 1 wherein the silane is combined with a processing oil or wax carrier.

11. The process of claim 1 wherein the untreated particulate support material comprises untreated clays, talc, Mg(OH)₂, calcium carbonate, glass, aluminum, copper, ferrous metals and alloys, nickel, zinc, lead, mica, MgO, silica, alumina, titania, zirconia or combinations thereof.

12. The process of claim 1 further comprising also blending one or more components selected from the group consisting of UV stabilizers, antioxidants, metal deactivators, processing aids, waxes, fillers, colorants and blowing agents.

13. The process of claim 1 wherein the free radical generator comprises one or more compounds selected from the group consisting of hydrogen peroxide, ammonium persulfate, potassium persulfate, diisopropyl peroxide, dilauryl peroxide, di-t-butyl peroxide, di(2-t-butylperoxyisopropyl)benzene, 3,3,5-trimethyl 1,1-di(tert-butyl peroxy)cylohexane, 2,5-dimethyl-2,5-di(t-butylperoxy)hexane, 2,5-dimethyl-2,5-di(t-butylperoxy)hexyne-3; dicumyl peroxide, t-butyl hydrogen peroxide, t-amyl hydrogen peroxide, cumyl hydrogen peroxide, acetyl peroxide, lauroyl peroxide, benzoyl peroxide, ethyl peroxybenzoate and 2-azobis(isobutyronitrile).

14. The process of claim 1 performed on a continuous basis wherein the blending step (a) is performed in a first mixing zone and the first blend including the particulate reinforcing material is moved into a second mixing zone wherein combining step (b) is performed.

15. A thermoplastic vulcanizate produced in accordance with the method of claim 1.

16. A composition for blending to produce a thermoplastic vulcanizate comprising:
a blended thermoplastic first polymer, an elastomeric second polymer, a carboxylic anhydride, free radical generator, and a particulate reinforcing material possessing sufficient surface moisture to be coupled with the thermoplastic first polymer and/or elastomeric second polymer when contacted with a coupling agent.

17. The composition of claim 16 wherein the thermoplastic first polymer is polypropylene and the elastomeric second polymer is EPDM rubber or SEBS rubber.

18. The composition of claim 16 wherein the reinforcing material is untreated clay.

19. The composition of claim 16 further comprising a coupling agent selected from the group consisting of organic diamines and aminosilanes.

20. The composition of claim 16 wherein the carboxylic anhydride is selected from the group consisting of isobutenylsuccinic, (+/−)-2-octen-1-ylsuccinic, itaconic, 2-dodecen-1-ylsuccinic, cis-1,2,3,6-tetrahydrophthalic, cis-5-norbornene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxylic, 3,4,5,6-tetrahydrophthalic, bromomaleic and dichloromaleic anhydrides, and the free radical generator is selcted from the group consisting of hydrogen peroxide, ammonium persulfate, potassium persulfate, diisopropyl peroxide, dilauryl peroxide, di-t-butyl peroxide, di(2-t-butylperoxyisopropyl)benzene, 3,3,5-trimethyl 1,1-di(tert-butyl peroxy)cylohexane, 2,5-dimethyl-2,5-di(t-butylperoxy)hexane, 2,5-dimethyl-2,5-di(t-butylperoxy)hexyne-3; dicumyl peroxide, t-butyl hydrogen peroxide, t-amyl hydrogen peroxide, cumyl hydrogen peroxide, acetyl peroxide, lauroyl peroxide, benzoyl peroxide, ethyl peroxybenzoate and 2-azobis(isobutyronitrile).
